(19) United States
(12) Patent Application Publication
(10) Pub. No.: US 2004/0187090 A1
(43) Pub. Date: Sep. 23, 2004

(54) Method and system for creating interactive software

(76) Inventor: Randal P. Meacham, Glen Ellyn, IL (US)

Correspondence Address: Reginald J. Hill, Jenner & Block, LLC, One IMB Plaza, 330 North Wabash, Chicago, IL, 60611, US

(21) Appl. No.: 10/641,366

(22) Filed: Aug. 14, 2003

Related U.S. Application Data
(60) Provisional application No. 60/456,855, filed on Mar. 21, 2003.

(51) Int. Cl. G06F 9/44

(52) U.S. Cl. 717/103; 717/110; 717/140

(57) ABSTRACT

A computerized method of efficiently creating interactive software applications includes developing a user interface pages for the application based on generic user interface components, data fields, navigation flow, logic constructs, and data access elements. Once the pages are defined for the application, the application developer may select an application platforms such as Java Server Pages or Active Server Pages, and the compiler will produce the necessary code for that application platform.

### CROSS-REFERENCE TO RELATED APPLICATIONS

This application claims priority from U.S. Provisional Patent Application Serial No. 60/456,855, filed on Mar. 21, 2003, entitled “Method for Creating Interactive Software Applications”, to Meacham, which is herein incorporated by reference.

### FIELD OF THE INVENTION

The present invention relates generally to graphical application development tools for creating interactive software applications, and in particular to a method and system for creating modular interactive software applications by creating graphical software application pages using generic user interface elements. The graphical software application pages are capable of being converted into software code for use in one or more existing software application platforms.

### BACKGROUND OF THE INVENTION

Graphical application development tools for software development are known. Previous graphical application development tools allow application developers to create simple interactive websites using a graphical editor. However, in order to develop more complicated applications, previous graphical application development tools require a developer to choose the particular software platform prior to developing the application model, and require application developers to write custom application code for the particular application platform. If the application developer wishes to run the application on a different application platform, the application developer must rewrite the custom code for the new application platform. Prior graphical application development tools also require expertise in the software language used to create code for the selected application platform.

For example, Dreamweaver software by Macromedia, Inc. of San Francisco, Calif. and FrontPage software by Microsoft Corp. of Redmond, Wash. provide graphical user interfaces for developing simple interactive web pages using standard HyperText Markup Language (“HTML”). However, application developers commonly use server-based application platforms such as Active Server Page (“ASP”) and Java Server Page (“JSP”) to supplement HTML to create more complex interactive applications, including applications utilizing external data repositories such as databases or XML documents. Dreamweaver and FrontPage allow application developers to add ASP or JSP code to their web pages, but require the application developers to know and use actual ASP or JSP syntax. If a developer wishes to move an application from the ASP platform to the JSP platform, the developer must rewrite the existing ASP code as JSP code. This requires the developer to not only spend significant time and effort but also to have experience with multiple application platforms. Such efforts become more complicated when the application accesses external data repositories. This is not desirable.

Therefore, a need exists for graphical application development tools that enable development of more complicated applications without requiring expertise in a particular application platform, provide simplified external data access and generate software code for one or more application platforms.

### SUMMARY OF AN EMBODIMENT OF THE INVENTION

In accordance with one embodiment of the invention, a method is provided for creating an interactive software application using a graphical application development tool. One example of such a software application is a website for collecting data from a customer according to a prepared script, with navigation flow in the application determined by the data supplied by the customer. However, any interactive software application is readily implemented in accordance with the present invention.

In accordance with the present invention, a graphical editor is provided. An application developer uses the editor in the graphical application development tool to construct a user interface for the software application by defining a series of pages for the application and the user interface components for each page, including graphical elements, data fields, and their graphical representation on the page. The application developer also defines functions using generic programming commands to define operations to be performed by the application. The application developer also specifies the navigation flow, that is, the sequence of the pages for the application, including logic to determine navigation flow at runtime. The application developer also defines interfaces to access external data repositories for the application, and maps the contents of the external data repository to fields of the application. The pages, user interface components, functions, navigation flow, and data repository access information for an application are stored as metadata in a database or other data storage medium. The application developer may create a hierarchical, modular application by specifying a collection of pages as a script module and a collection of script modules as a project.

The graphical application development tool generates the application for a specific application platform. For example, the application developer may choose to operate the software application on the Active Server Page (“ASP”) application platform from Microsoft Corp., the Java Server Page (“JSP”) application platform from Sun Microsystems, Inc., PHP: Hypertext Processor (“PHP”) or other application platforms. Once the application platform is determined, the graphical application development tool compiles the application metadata from the database into code specific to that application platform. Because the application developer constructs the application using the graphical application development tool, and the graphical application development tool generates the application platform-specific code for the application, the application developer does not need general programming expertise or experience with the specific application platform.

### BRIEF DESCRIPTION OF THE DRAWINGS

FIG. 1 is a schematic block diagram of a graphical application development tool in accordance with the present invention.

FIG. 2 is an illustrative screen of an application development tool editor in accordance with the present invention.

FIGS. 3A,3B, 3C and 3D are block diagrams of a database model used in connection with an embodiment of the present invention.

FIG. 4 is an illustrative screen of a web application page developed in accordance with the present invention.

FIG. 5 is an illustrative screen of a web application page being edited in application development tool editor in accordance with the present invention.

FIG. 6 is an illustrative screen of an XML interface request of an application developed in accordance with the present invention.

FIG. 7 is an illustrative screen of an XML interface response of an application developed in accordance with the present invention.

### DETAILED DESCRIPTION OF THE INVENTION

I. Application Definition

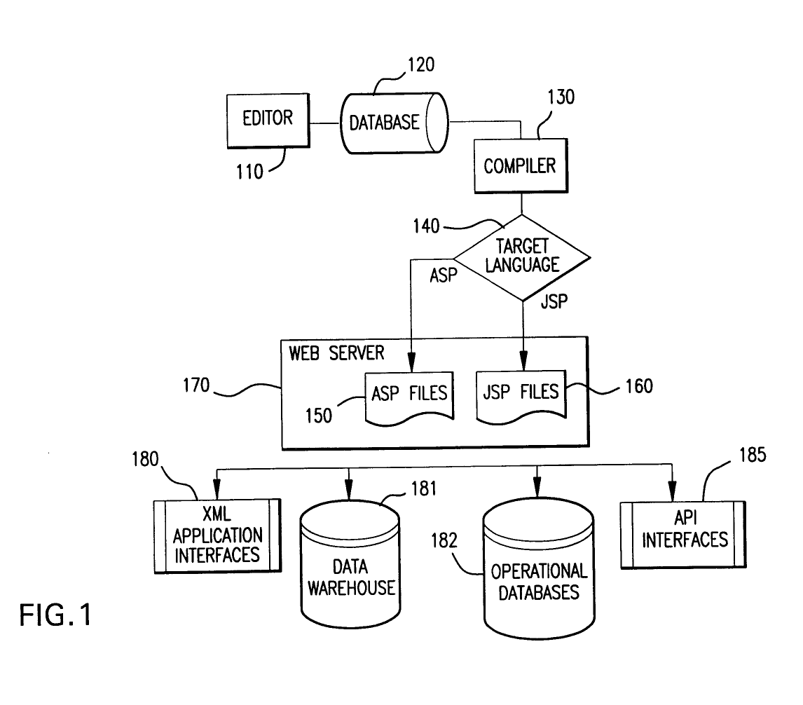

FIG. 1 is a schematic block diagram of a graphical software application development tool in accordance with an embodiment of the present invention. In a preferred embodiment, the graphical software application development tool is executed on any standard personal computer or workstation having a display, a processor, a storage device, and an input device such as a keyboard or a mouse. Editor 110 allows an application developer to construct the user interface for the software application by defining a series of pages for the application, the user interface components for each page, navigation flow between the pages, functions, and external data repository access, as described in more detail below. The user interface components are generic user interface components generally used in designing graphical applications, regardless of application platform. The application developer selects each user interface component using editor 110 from a list of generic user interface components supported by editor 110. Editor 110 stores the application information as metadata in database 120. Database 120 is any data storage medium, including a relational database such as Microsoft Access, or alternatively any file system or computer memory. Although different application platforms provide the same generic user interface component functionality such as variables, text entry fields or dialog boxes, each application platform requires code specific to that application platform to manage and display the user interface components at run-time. The compiler 130 converts the selected generic user interface components into the appropriate code files 150, 160 for the final application based on the application platform 140. For example, the application developer may select the target language 140 as ASP or JSP, and the compiler 130 will create ASP code files 150 or JSP code files 160, respectively. These ASP code files 150 or JSP code files 160 are deployed on a web server 170, where they may be accessed using a web browser, and to access data from repositories such as an eXtensible Markup Language (“XML”) document 180, a data warehouse 181, operational databases 182, as well as to access data from other applications through application programming interfaces (“APIs”) 183. Because the application developer selects generic user interface components using editor 110 and compiler 130 generates the application platform-specific code for managing and displaying the components, the application developer is not required to have expertise in programming generally or experience with the specific application platform.

Applications are composed of individual graphical screens known as pages. Pages may contain user interface components and data elements that the application developer places on the pages using the editor 110. In a preferred embodiment, an application page corresponds to an individual web page that is displayed to the user when the application executes. User interface components for each page include graphical and textual elements such as images, button widgets, radio boxes, as well as other user interface components known to software user interface designers. In a preferred embodiment, the application developer selects pre-defined user interface components from database 120.

Pages allow the entry or display of data elements by the application user through the use of fields, which are similar to variables in programming languages. A field can be any commonly known data type such as an integer, string, or Boolean. The field may be associated with a user interface component such as a text entry box, check box, radio button or any other known data entry user interface component, allowing the application to display the value of the field on the page or allowing the user to modify the value. Fields may also represent more complex data structures such as tables, for which multiple columns may be defined and for which multiple data rows may exist in the application. A table may also include other tables. Because fields are stored as metadata in the database 120 and then associated with pages, one field may be associated with multiple pages, similar to global variables in programming languages. In an embodiment of the present invention in which application pages correspond to web pages, such shared fields represent session variables that are accessible by each web page during a single web browsing session. This allows an application to maintain data as the user navigates between different pages of the application.

The graphical application development tool allows the application developer to create modular software applications by grouping pages together into a module known as a script. The application developer also defines a default navigation order in which the pages in the script are to be displayed. An application developer can also group collections of scripts together to form a module known as a project, and can define a default navigation order in which the scripts in the project are to be executed. In a preferred embodiment, scripts, navigation order, and projects are determined using editor 110.

The graphical application development tool allows the application developer to create more complex interactive software applications by defining activities to be performed by the application, known as actions. Actions include navigation flow between pages known as branches, custom logic known as functions, and access to external data repositories known as interfaces. The different types of actions are described in more detail below. Actions may also be referred to as script buttons. Actions are stored as metadata in database 120.

The graphical application development tool allows the application developer to control the navigation flow of pages within a script, or between pages in different scripts, by defining branches. The application developer associates one or more branches with a page and identifies the destination script and page to which the application will navigate when a branch is executed. A branch may be associated with a user interface component on the page such as a button. For example, the application developer may define a branch for a page associated with a “Next Page” button. When the user activates the Next Page button, the application executes the next page branch and navigates to the next page in the previously defined default navigation order. A branch may also be defined to conditionally execute, depending upon certain logic, by defining a branch command in a function as described below. For example, the application developer may force a user to enter valid data in data fields on a page before the user is allowed to navigate to the next page. The application developer associates a conditional branch with a “Next Page” button that will only execute if the value of a specified field value meets certain criteria. The editor 110 allows the application developer to specify the field to be tested, the operator to apply, and the value to be compared. The editor 110 automatically displays only valid operators and values for the type of the specified field. For example, if the field is numeric, the valid operators are any numeric comparison and the valid values are any numeric values. On the other hand, valid operators for a check box field are only ‘equal’ and ‘not equal’, and the valid values are only ‘true’ or ‘false’.

The graphical application development tool also allows the application developer to provide access to external data repositories such as databases or XML documents by defining interfaces. For example, the application developer defines XML interfaces for posting information to, and receiving information from external systems using XML documents. An XML document consists of a hierarchical set of records, where each record is delimited by XML tags identifying the type of data contained in the record. For each XML interface, the application developer uses editor 110 to specify the external system and associate the tags of the XML document with fields of the application. The application developer may also associate a tag with a predefined static value instead of a field, or designate the tag as not associated with a field or value.

Associating XML tags with table fields simplifies associating values for repeating groups of information. An XML document may include a list of multiple records having the same tag. For example, an XML document may contain a list of products offered by a company, where each product is described in a separate record but each record is identified by the same tag. In such a case, the tag may be associated with a particular column in a table field, and each record in the XML document corresponding to the tag will be associated with the particular column for each record in the table field.

The graphical application development tool can automate many of the tag definition tasks by importing an XML Document Type Definition (“DTD”) file or an XML Schema (“XSD”) file for an XML document and automatically constructing an XML interface for that document. The application developer merely needs to associate the application fields with the XML interface tags.

When the application executes an XML interface for posting or requesting an XML document, the application constructs an XML document by retrieving the data for each tag from the associated fields or static values as specified in the XML interface, transmits the XML document to the specified external data repository, waits for an XML document as a response, extracts the data from the XML tags contained in the XML response document and stores the data from each tag into its associated fields.

Similarly, the graphical application development tool allows the application developer to define interfaces for querying data from or updating data contained in an external database by associating the columns of the database tables or database views to fields in the application as described above for the XML document tags.

If the application requires application platform-specific code that is not supported by the generic commands available for a function as described below, the application developer can define an interface that, upon execution, retrieves an include file from a specified Uniform Resource Locator (“URL”) and executes the application platform-specific code.

The application developer specifies complex operations to be performed by the application by defining functions containing the logic for the operation. This is similar to functions used in programming languages. Functions may be associated with a user interface component and executed at application runtime when the user interface component is activated, such as clicking on a button. Functions may also be associated with a page and specified to be executed automatically when a user enters or exits a page. Functions are defined as a sequence of one or more steps, where each step includes a sequence of one or more commands. The application developer selects each command to be performed from a list of available commands, selects the field or fields on which to perform the command, and determines the order each command should be executed in a step. Commands may also include actions such as branches or database access. For example, the developer may create a function to assign the value of one field to another field, or assign a fixed value to one of the fields. Because the available commands are similar to basic commands commonly used in many programming languages, and the list of available commands is presented to the application developer through the graphical application development tool, the application developer does not need extensive general programming expertise or experience with the particular application platform to construct functions using the present invention.

Table I contains a list of generic commands that may be included in a function, in the order determined by the application developer.

TABLE I

| Command | Description |
|---|---|
| ALERT | Alert a user at runtime with a pop up message. The source of the |
| | message can be static text or from a predefined field in the database. |
| CAPTURE | Capture the contents of a script page, including all HTML, fields and |
| | values, style sheets and graphics into a predefined field. This field |
| | can then be used as source for creating PDF files and emails |
| | automatically using XML servers built into the invention. |
| COMMAND | Specify direct code for a target environment such as ASP or JSP |
| | code. |
| COMMENT | Comment that appears in the generated ASP or JSP code. |
| DIM | Define a variable for use in other action statements. |
| LOCAL | Define a variable for use only in the current action. |
| EXECUTE | Execute an action from within an action. |
| IF, ELSE, ELSEIF, | Specify conditional action steps. |
| ENDIF | |
| RECALC | Force recalculation of function fields during the execution of an |
| | action. |
| RESPONSE | Write output to the Web Page being displayed at runtime. |
| SET | Move data from one field or variable to another field or variable. |
| WHILE, ENDWHILE | Create a conditional loop. |
| BRANCH, NEXT | Direct flow from one script page to another from within the action. |
| PAGE, PREVIOUS | |
| PAGE, RESTART | |
| API Interface | Execute a predefined application programming interface (“API”). |
| Database Interface | Execute a predefined Database Interface. |
| XML Interface | Execute a predefined XML Interface. |
| LOAD SESSION, | Load or save an entire session to a file using XML, including all field |
| SAVE SESSION | values and navigational flow information so the same user, or a |
| | different one, can reload the Web session at a later time and not lose |
| | any information or logic flow. |
| ADD ROW | Add new rows to a table with existing values for fields. |
| INSERT ROW | Add a new row to a table with blank values for fields. |
| DELETE ROW | Delete the current row in a table. |
| REMOVE ALL ROWS | Delete all rows in a table. |
| UPDATE ROW | Update the current row in a table with values in associated fields. |
| UNSELECT ALL | Unselect all rows in a table. |
| ROWS | |
| FOR EACH ROW, | Step through the rows in a table. |
| NEXT ROW | |

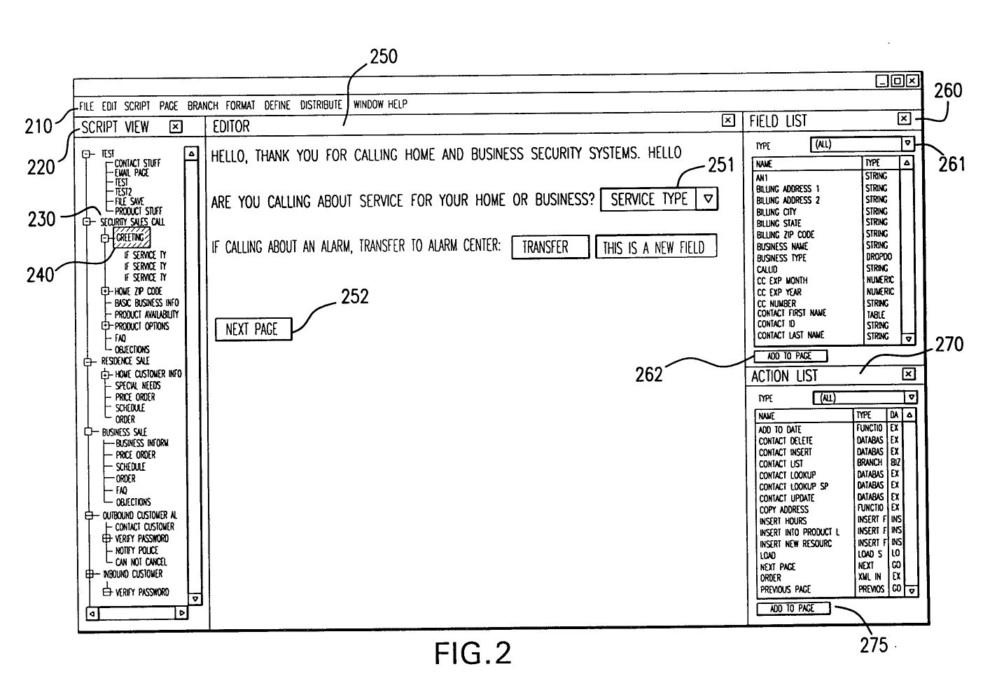

FIG. 2 is an illustrative screen of editor 110 in one embodiment of the present invention. More specifically, FIG. 2 shows a page being edited using editor 110 for a home and security services sales application. Menu Bar 210 provides drop down menus containing actions to be performed in editor 110. Script View window 220 provides a hierarchical view of the scripts and pages capable of being edited. Script entry 230 is a script entitled “Security Sales call.” Page entry 240 is a page associated with script entry 230. Page entry 240 is highlighted in Script View window 220 to show that it is currently being edited. Editor window 250 shows a graphical representation of the page selected in Script View window 220, in this case page entry 240. Drop down box 251 entitled “Service Type” is an example of a drop-down entry field on page entry 240. Next page button widget 252 is an example of a button on page entry 240. Field List window 260 lists all fields available to be placed on the page. Fields are added by selecting a field from the list of available fields and clicking the “Add to Page” button 262. Action List 270 provides a list of available actions to be added to the page, including branches, interfaces and functions. Actions may be added by selecting an action from the list of available actions and clicking the “Add to Page” button 275. A default catalogue of fields and actions are preferably provided with editor 110. Most preferably, the catalogue is customized for the types of applications that are created.

II. Application Storage

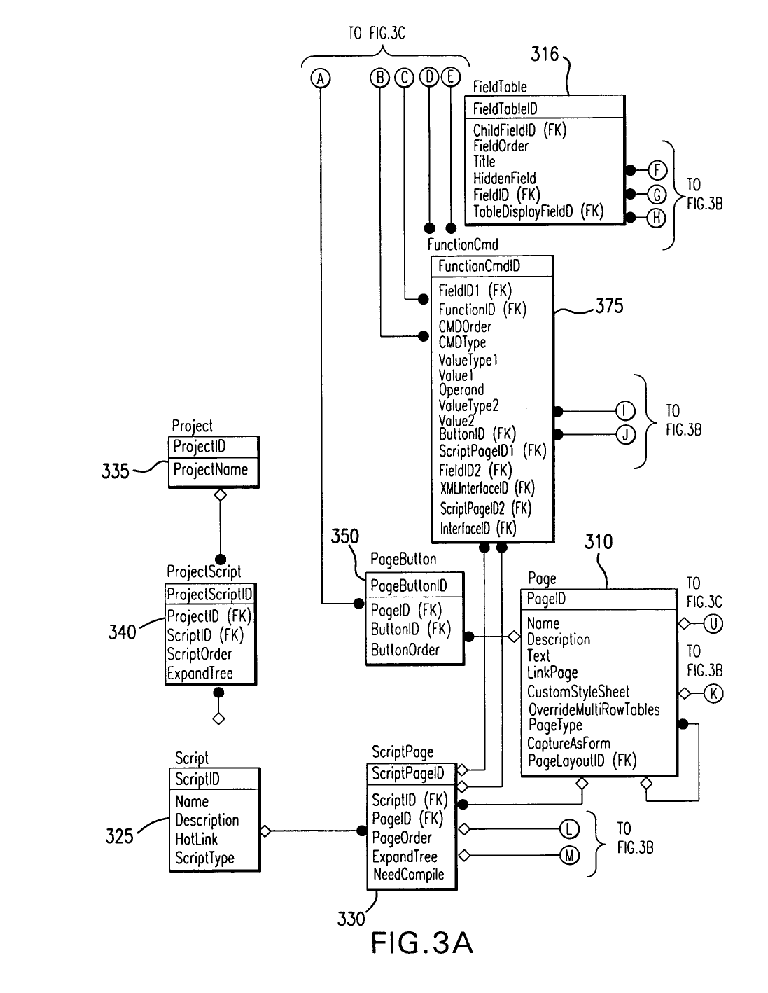

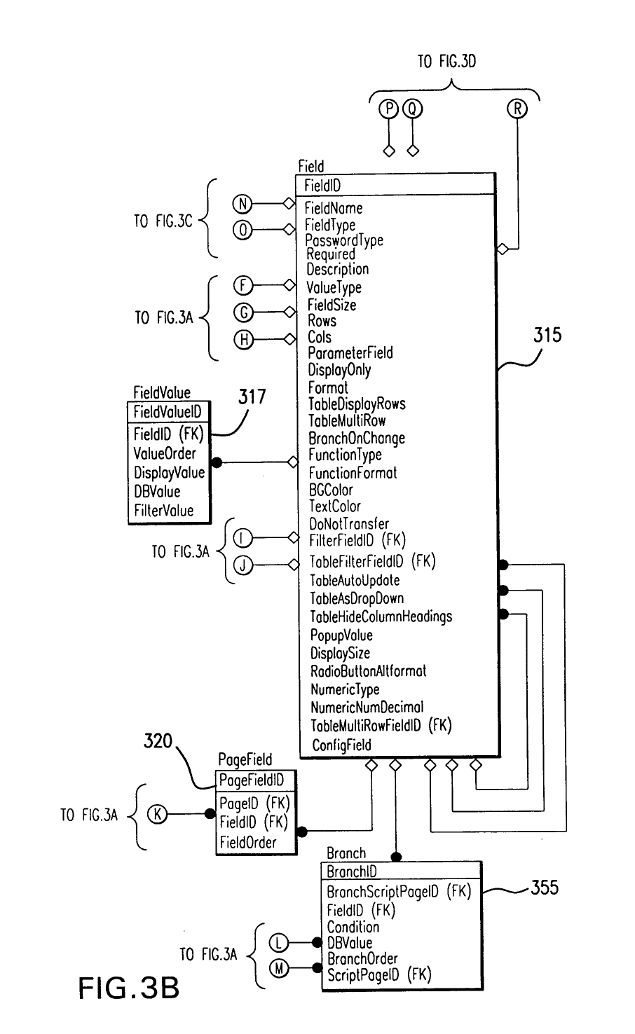

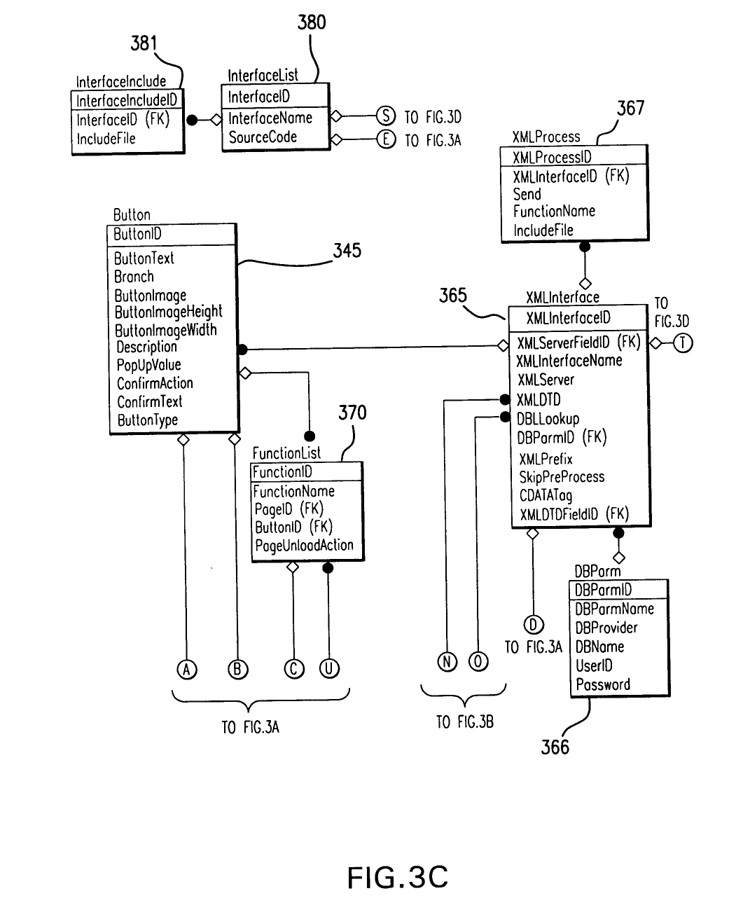

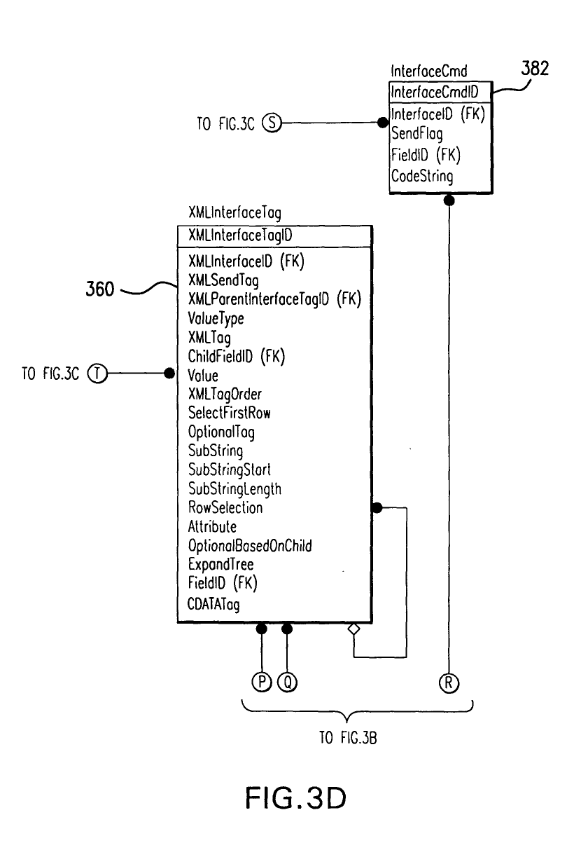

The elements of the application, including projects, scripts, pages, user interface components, fields, and actions are stored in database 120 as metadata. Any database may be used to store the application metadata, although a preferred embodiment utilizes a relational database, as is well known in the art, such as Microsoft Access. FIGS. 3A, 3B, 3C and 3D show a database model of database 120 in one embodiment of the present invention. More specifically, FIGS. 3A, 3B, 3C and 3D show an entity relationship diagram of the relational database 120 of the embodiment. Each rectangle in FIGS. 3A, 3B, 3C and 3D indicates a table in database 120. The text contained in each table lists the data columns of that table. Each record (also known as a row) in a table can contain a value for each column in the table, although a record may not have a value for certain columns. The lines and symbols connecting the tables indicate the relationship between the data contained in the tables. Each line connecting two tables includes a symbol at each end of the line. An open diamond touching a first table indicates a one-to-many relationship with the second table at the other end of the connecting line, meaning that one record in the first table is associated with one or more records in the second table. A closed circle touching a first table means that each record in the first table is only associated with one record in the other table that the line touches.

Page Table 310 contains metadata for pages stored in database 120. Variables used in the software application are stored as fields in Field Table 315. As described above, the software developer adds fields to pages. Because a field may appear on multiple pages, PageField Table 320 stores the association between pages and fields. Each record in the PageField Table 320 contains an association between one field and one page, as well as the tab order and position in which the field is to be displayed on the page. As described above, one record in the Page Table 310 is associated with multiple records in PageField Table 320 and one record in Field Table 315 is associated with multiple records in PageField Table 320, but each record in PageField Table 320 is only associated with one record in Page Table 310 and one record in Field Table 315. If a field is a table field, FieldTable 316 stores a list of all fields in the table field. An application developer specifies lists of pre-defined values for fields such as drop down boxes in FieldValue Table 317.

Script Table 325 contains metadata for scripts defined in database 120. ScriptPage Table 330 contains the associations between scripts and pages. Each record in ScriptPage Table 330 contains an association between one script and one page, as well as the default order in which the page is to be displayed in the script. Project Table 335 contains the list of defined Projects. ProjectScript Table 340 contains the associations between Projects and scripts. Each record in ProjectScript Table 340 contains an association between one Project and one script, as well as the default order in which the script is to be executed in the Project. Branches are defined in Branch Table 355, and are associated with entries in ScriptPage Table 335. Interfaces to XML documents or database data repositories are defined in XMLInterface Table 365. XMLInterface Tag Table 360 defines a mapping between the data elements of an XML interface or database defined in XMLInterface Table 365 and fields defined in Field Table 315. Location and connection parameters for database interfaces are defined in DBParm Table 366. Application developers may define actions to be performed on data before or after sending or receiving in XMLProcess Table 367. Interfaces to external APIs are defined in InterfaceList Table 380, InterfaceInclude Table 381 and InterfaceCmd Table 382. InterfaceList Table 380 contains a list of interfaces to external APIs. InterfaceInclude Table 381 defines any include files necessary to access such APIs. InterfaceCmd Table 382 contains a list of commands

Functions are defined in FunctionList Table 370. For each Function in FunctionList Table 370, FunctionCmd Table 375 contains an entry for each step of the function. Each step entry in FunctionCmd Table 375 contains the command to be executed for that step, the order in which the step is to be executed, the field or fields to be operated on or evaluated, and any value or values to be operated on or evaluated.

Functions and interfaces may be associated with pages in the application as defined in Button Table 345. Each record in Button Table 345 indicates an action to be performed. Actions to be performed when the user activates a button in the application user interface are associated with pages in ButtonPage Table 350. Functions and interfaces that are not associated with a user interface component, such as page entry and exit functions, may be defined by associating the FunctionList Table 370 record with a record in Page Table 310.

III. Application Generation

Once the application developer selects the user interface for the application, the application developer generates the application platform-specific code for the application. Through a menu in editor 110, the application developer elects to generate a specific project, script, page, or everything stored in database 120. The compiler 130 retrieves the selected application elements from the database 120 and constructs generic command strings, also known as pseudo-code, based upon the elements. For example, a page in a Web-enabled application may contain a function to determine if the page being visited is a particular page, and if so, perform a certain desired operation. A generic command string for this logic is “IF ScriptPageID=299309 THEN <perform OPERATION>”. This generic command string is then passed to the parser. The parser processes the generic command by parsing the command string into its component tokens. Commands can be divided into tokens by the use of spaces or other specified dividing characters. The parser analyzes each token and determines the type of statement to be compiled. For the command string above, the parser will determine that the command is an ‘IF’ command. The parser then calls the parser class for the ‘IF’ command to process the command down into its respective parts. The parser class for an ‘IF’ statement identifies the generic syntax of the statement as one value to be tested, the operation to test the value, and a second value against which the first value is tested. In the example above, the first value is the ScriptPageID, the test operation is ‘equals’, and the value against which the ScriptPageID is to be tested is the numeric value ‘299309’, which corresponds to the unique identifier of the selected page in ScriptPage Table 315. Once the generic syntax is identified, the parser passes the generic syntax to a syntax specific object to convert the specified command into the syntax required for the selected application platform. The parser contains syntax classes for commonly used basic constructs for building applications. The parser also allows nested statements to be prepared by tracking the indentation level of the statement. In the above ‘IF’ statement example, the parser executes a statement similar to “syntax.opIf (<Indentation Level>, ScriptPageID, ‘eq’, ‘299309’).” If the target application platform is ASP, the syntax object will output “IF ScriptPageID=299309.” If the target application platform is JSP, the syntax object will output “If (ScriptPageID.equals(299309)).”

The parser of a preferred embodiment is written using the Visual Basic programming language. Tables IIA, IIB and IIC contains a list of parser functions used by this embodiment to represent the valid available generic programming commands. Parser functions in this embodiment are internal to the parser and are not to be confused with functions defined for an application as described above. For each parser function listed in Tables IIA, IIB and IIC, the arguments required by the generic syntax are also listed. Table IIA lists functions for commands that perform an action. Table IIB lists functions for commands that generate a complete code section for a specific purpose. Table IIC lists functions for commands that generate a partial statement for use within other statements.

TABLE IIA

| Command | Function | Description |
|---|---|---|
| OPEN | Public Sub | Opens a target file |
| OUTPUT | openOutputFile | in target path for |
| FILE | (filename As String, | the specific language |
| | path As String) | being generated, |
| | | including necessary support |
| | | files (e.g., a JAVA parser for |
| | | JSP applications). |

TABLE IIB

| Command | Function | Description |
|---|---|---|
| IF FORM VARIABLE | Public Function | Determine if a variable |
| EXISTS | opIfFormVarExists(numtab As | exists in a URL. |
| | Integer, formvar As String) As | |
| | String | |
| ELSE IF FORM VARIABLE | Public Function | ElseIf that checks for the |
| EXISTS | opElseIfFormVarExists(numtab | existence of a variable in a |
| | As Integer, formvar As String) As | URL |
| | String | |
| IF | Public Function opIf(numtab As | IF statement that compares |
| | Integer, fieldname As String, op | the values of two variables. |
| | As String, val As String) As String | |
| REDIRECT | Public Function | Branch to a target Page |
| | opRedirect(numtab As Integer, url | indicated by the URL. |
| | As String) As String | |
| END IF | Public Function opEndIf(numtab | END IF statement |
| | As Integer) As String | |
| SET SESSION VARIABLE | Function opSetSessionVar(numtab | Set the value of a session |
| | As Integer, fieldname As String, | variable. |
| | val As String) As String | |
| EQUAL | Function opEqual(numtab As | Set one field equal to |
| | Integer, fieldname As String, val | another field |
| | As String, Optional valtype As | |
| | String) As String | |
| DECLARE FIELD | Function opDeclareField(numtab | Declare a variable for a |
| | As Integer, fieldtype As String, | specified type |
| | fieldname As String, Optional | |
| | numcol As String) As String | |
| ELSE | Function opElse(numtab As | Else Statement |
| | Integer) As String | |
| ELSE IF | Public Function opElseIf(numtab | Else If statement |
| | As Integer, fieldname As String, | |
| | op As String, val As String) As | |
| | String | |
| SET TABLE ROW | Function opSetTableRow(numtab | Set values for a row in a |
| | As Integer, tablename As String, | table |
| | idx As String) As String | |
| SET TABLE SIZE | Function opSetTableSize(numtab | Set the number of rows in |
| | As Integer, tablename As String, | a table |
| | idx As String) As String | |
| ADD TABLE ROW | Function | Add a new row to a table |
| | opAddTableRow(numtab As | |
| | Integer, tablename As String) As | |
| | String | |
| FOR | Function opFor(numtab As | For statement used in a |
| | Integer, idx As String, min As | loop |
| | String, max As String) As String | |
| END FOR | Function opEndFor(numtab As | End of a For Loop |
| | Integer) | |
| ALLOCATE FIELD | Function opAllocateField(numtabs | Declare a variable for use |
| | As Integer, fieldtype As String, | in Actions |
| | fieldname As String, Optional | |
| | numcol As String) | |
| GET DATE | Function opGetDate(numtab As | Format a date field |
| | Integer, fieldname As String, | |
| | datestring As String, datetype As | |
| | String) As String | |
| RESPONSE | Function opResponse(numtab As | Write text to the screen at |
| | Integer, response As String, | run time |
| | responseType As String) As String | |
| COMMENT | Function opComment(numtabs As | Write a comment into the |
| | Integer, val As String) As String | target source file |
| EXIT FOR | Function opExitFor(numtab As | Exit a for loop in the |
| | Integer) As String | middle of the loop |
| LOAD XML DOCUMENT | Function | Load an XML document |
| | opLoadXMLDoc(numtab As | from a string |
| | Integer, fieldname As String, val | |
| | As String) As String | |
| WHILE | Function opWhile(numtab As | While Loop |
| | Integer, fieldname As String, op | |
| | As String, val As String) As String | |
| END WHILE | Function opEndWhile(numtab As | End of a While loop |
| | Integer) | |
| FILE SAVE | Function opFileSave(numtab As | Save data to a flat file. |
| | Integer, fieldname As String, | |
| | filename As String, filedata As | |
| | String) As String | |
| LOAD XML DOCUMENT | Function | Load an XML document |
| FROM FILE | opLoadXMLDocFromFile(numtab | from a file |
| | As Integer, fieldname As String, | |
| | filename As String, filedata As | |
| | String) As String | |
| NO CACHE | Public Function | Direct the browser to not |
| | opNoCache(numtab As Integer) | cache a page. |
| | As String | |

TABLE IIC

| Command | Function | Description |
|---|---|---|
| GET FORM VARIABLE | Public Function | Retrieve the value of a |
| | getFormVar(formvar As | variable from a URL |
| | String) As String | |
| GET INCLUDE FILE | Public Function | Format an include file name |
| | getIncludeFile(filename As | |
| | String, Optional dontaddsuffix | |
| | As Boolean) As String | |
| GET LINK | Public Function getLink(url As | Return a formatted anchor or |
| | String, txt As String) As String | link |
| GET SESSION VARIABLE | Function | Retrieve the value for a |
| | getSessionVar(fieldtype As | session variable |
| | String, fieldname As String) | |
| | As String | |
| GET TABLE ROW | Function | Retrieve a row from a table |
| | opGetTableRow(numtab As | |
| | Integer, tablename As String, | |
| | idx As String) As String | |
| GET COLUMN | Function getCol(fieldname As | Retrieve the value from a |
| | String, col As String, Optional | column in a table. Cast the |
| | casttype As String) As String | value into a specified type |
| | | such as STRING. |
| GET TABLE SIZE | Function | Retrieve the number of rows |
| | getTableSize(tablename As | in a table |
| | String) As String | |
| GET IMAGE | Function getImage(imagename | Format an image name |
| | As String) As String | |
| GET STRING | Function getString(val As | Format a string |
| | String) As String | |
| GET LITERAL | Function getLiteral(val As | Format a literal |
| | String) As String | |
| GET NUMBER | Function getNumber(val As | Format a number |
| | String) As String | |
| GET BOOLEAN | Function getBoolean(val As | Format a boolean |
| | String) As String | |
| GET COPY | Function getCopy(val As | Returns a new copy of a |
| | String) As String | variable |
| GET NODE | Function getNode(val As | Retrieve an XML Node |
| | String) As String | |
| GET NODE FIRST CHILD | Function | Retrieve the first child of a |
| | getNodeFirstChild(val As | parent XML Node |
| | String, tag As String) As String | |
| GET NODE ATTRIBUTE | Function getNodeAttribute(val | Return the value of an |
| | As String, tag As String) As | attribute associated with an |
| | String | XML node |
| GET NODE NEXT SIBLING | Function | Get next sibling node in the |
| | getNodeNextSibling(val As | XML tree |
| | String) As String | |
| GET NODE VAL | Function getNodeVal(val As | Retrieve the value of an XML |
| | String) As String | node |
| GET RETURN | Function getReturn( ) As String | Format a return character |
| | | appropriate for the target |
| | | platform |
| GET SUBSTRING | Function getSubString(val As | Generate a substring |
| | String, startidx As String, | statement |
| | length As String) As String | |
| GET LENGTH | Function getLength(val As | Return the length of a string |
| | String) As String | |
| GET OPERAND | Function getOp(op As String) | Return an operand |
| | As String | appropriate for a specific |
| | | platform. For example not |
| | | equal to would be the |
| | | characters “<>” for ASP and |
| | | the characters “!=” for JSP. |

Once the scripts are compiled into target code for the selected application platform, the application developer may test and distribute the application. The application is then run with a web browser or another suitable application environment.

### IV. EXAMPLE APPLICATION

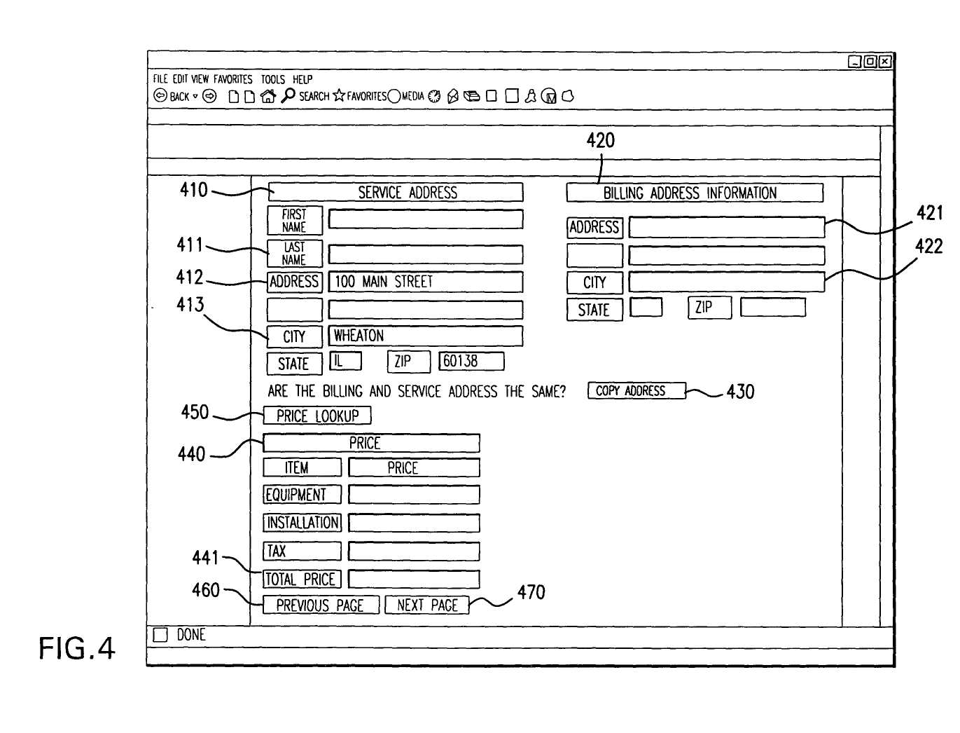

FIG. 4 shows an illustrative screen of a web page for an ASP-based application developed in accordance with the present invention for ordering home and business security services. In this embodiment, the user of the application is an agent receiving order information from an end customer. Service Address section 410 contains the customer's address for service, including data entry fields for customer name 411, service address 412 and service city 413. Billing Address section 420 contains the customer's billing address information, including data entry fields for billing address 421 and billing city 422. Copy Address button 430 allows the user to copy information from the Service Address section 410 to the Billing Address section 420 if the user's service and billing address are the same. When the user clicks on the Copy Address button 430, the web server executes the ASP code associated with the Copy Address button 430. Price section 440 allows the user to view price information regarding products entered on previous screens. Total Price field 441 shows the total price for the entered products. Price Lookup button 450 retrieves data from the web server containing pricing for previously entered products and services in order to populate data entry fields in Price section 440. Previous Page button 460 and Next Page button 470 allow navigation through the pages of the application.

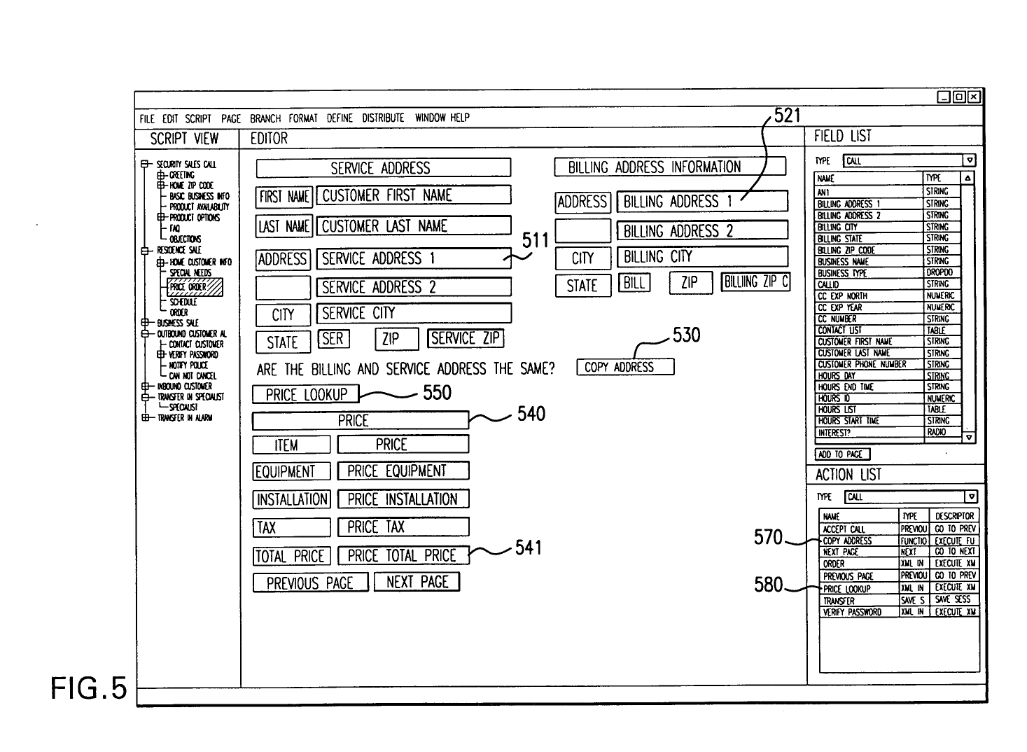

The application developer constructs the application in the editor 110. FIG. 5 shows a screen shot of the editor 110 in the process of editing the page shown in FIG. 4. The application developer edits the page, containing user interface components including service address field component 511, billing address field component 521, copy address button component 530 and price lookup button component 550. The user interface component metadata is stored in database 120. The copy address button component 530 corresponds to the Copy Address button 430 of FIG. 4, and the service address field component 511 and billing address field component 521 correspond to the service address 411 and billing address 412 fields of FIG. 4, respectively. In order to perform the copy address functionality, the application developer creates a Copy Address function 570 and associates the function with the copy address button component 530. The application developer defines the steps of the function in the editor 110. The Copy Address function is stored as a record in Function Table 370. The association between the copy address button component 530 and copy address function 570 is stored in database 120 in Button Table 345.

One example of commands associated with the copy address function 570 to validate the contents of the service address information and copy the service address information to the billing address information is as follows:

```
IF FIELD( SERVICE STATE) = “”
  ALERT “Please provide a State”
ELSEIF FIELD( Service City) = “”
  ALERT “Please provide a city”
ELSEIF FIELD ( ServiceAddress1) = “”
  ALERT “Please provide an address”
ELSE
  SET FIELD (BillingAddress1) = FIELD(ServiceAddress1)
  SET FIELD (BillingAddress2) = FIELD(ServiceAddress2)
  SET FIELD (BillingCity) = FIELD(ServiceCity)
  SET FIELD (BillingState) = FIELD(ServiceState)
  SET FIELD (BillingZipCode) = FIELD(ServiceZipCode)
ENDIF
```

When the application developer generates the application, the compiler 130 first translates the copy address action 570 into the following generic pseudo-code command strings:

```
IF SESSION(WebScriptClickedButton) = “WebScriptbutton118” THEN
  IF SESSION(WebScriptfield102) = “” THEN
    WebScriptUserAlertMessage = WebScriptUserAlertMessage & COMMAND(“Please
    provde a State.”) &“ ”
  ELSEIF Session(“WebScriptfield101”) = “” THEN
    WebScriptUserAlertMessage = WebScriptUserAlertMessage & COMMAND(“Please
    provide a city.”) & “ ”
  ELSEIF Session(“WebScriptfield98”) = “” THEN
    WebScriptUserAlertMessage = WebScriptUserAlertMessage & COMMAND(“Please
    provide an Address.”) & “ ”
  ELSE
    SESSION (WebScriptfield113) = SESSION (WebScriptfield98)
    SESSION (WebScriptfield114) = SESSION (WebScriptfield99)
    SESSION (WebScriptfield115) = SESSION (WebScriptfield101)
    SESSION (WebScriptfield116) = SESSION (WebScriptfield102)
    SESSION (WebScriptfield117) = SESSION (WebScriptfield100)
  ENDIF
ENDIF
```

Each field referenced in the function 570 is converted to a session variable for the application in the pseudocode above. Each field name in function 570 is translated into the unique identifier for the field in Field Table 315 in database 120. For example, the field named BillingAddress1 above corresponding to the first line of Billing Address field component 521 has the unique identifier in the this application of “WebScriptfield113.”

The compiler 130 then translates the generic command strings into their application platform specific language using the process previously outlined. The compiler 130 generates the following ASP-specific code:

```
‘Copy Address CLICK
IF Session(“WebScriptClickedButton”) = “WebScriptbutton118” THEN
  IF Session(“WebScriptfield102”) = “” THEN
    WebScriptUserAlertMessage = WebScriptUserAlertMessage & “Please provde a State.”
    & “ ”
  ELSEIF Session(“WebScriptfield101”) = “” THEN
    WebScriptUserAlertMessage = WebScriptUserAlertMessage & “Please provide a city.”
    & “ ”
  ELSEIF Session(“WebScriptfield98”) = “” THEN
    WebScriptUserAlertMessage = WebScriptUserAlertMessage & “Please provide an
    Address.” & “ ”
  ELSE
    Session(“WebScriptfield113”) = Session(“WebScriptfield98”)
    Session(“WebScriptfield114”) = Session(“WebScriptfield99”)
    Session(“WebScriptfield115”) = Session(“WebScriptfield101”)
    Session(“WebScriptfield116”) = Session(“WebScriptfield102”)
    Session(“WebScriptfield117”) = Session(“WebScriptfield100”)
  END IF
END IF
```

If the application developer wishes to create a version of the application for the JSP application platform, the application developer selects to generate JSP application platform code, and the compiler 130 generates the following code:

```
//Copy Address CLICK
if( session.getAttribute(“WebScriptClickedButton”).equals(“WebScriptbutton118”) )
{
  if( session.getAttribute(“WebScriptfield102”).equals(“”) )
  {
    WebScriptUserAlertMessage = WebScriptUserAlertMessage + “Please provde a State.” +
    “ ”;
  }
  else if( session.getAttribute(“WebScriptfield101”).equals(“”) )
  {
    WebScriptUserAlertMessage = WebScriptUserAlertMessage + “Please provide a city.” +
    “ ”;
  }
  else if( session.getAttribute(“WebScriptfield98”).equals(“”) )
  {
    WebScriptUserAlertMessage = WebScriptUserAlertMessage + “Please provide an
    Address.” + “ ”;
  }
  else
  {
    session.setAttribute(“WebScriptfield113”, session.getAttribute(“WebScriptfield98”));
    session.setAttribute(“WebScriptfield114”, session.getAttribute(“WebScriptfield99”));
    session.setAttribute(“WebScriptfield115”, session.getAttribute(“WebScriptfield101”));
    session.setAttribute(“WebScriptfield116”, session.getAttribute(“WebScriptfield102”));
    session.setAttribute(“WebScriptfield117”, session.getAttribute(“WebScriptfield100”));
  }
}
```

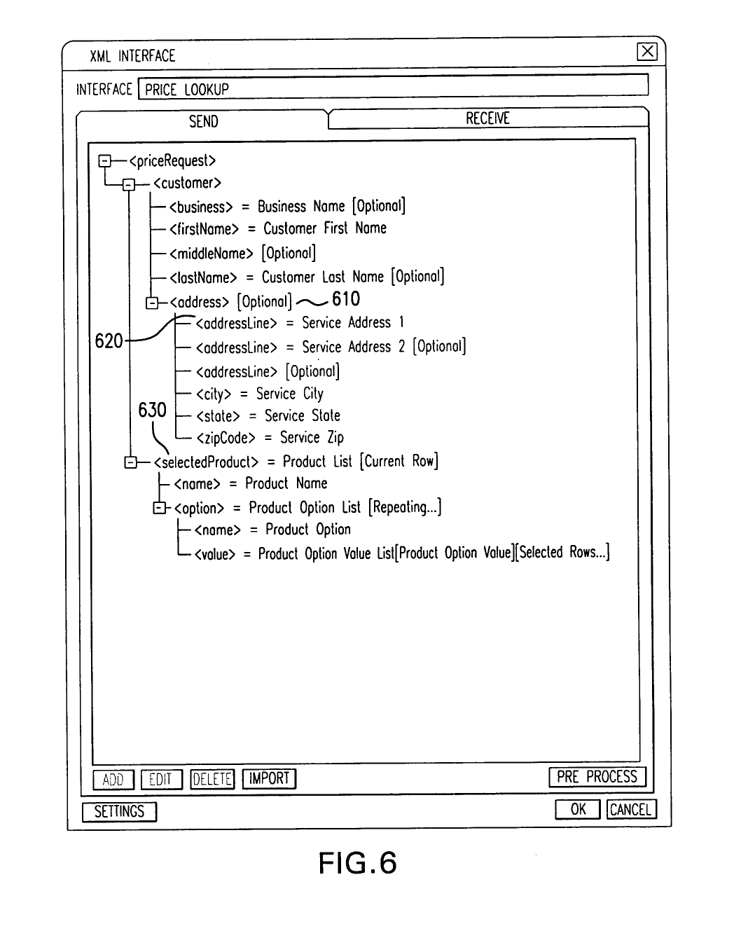

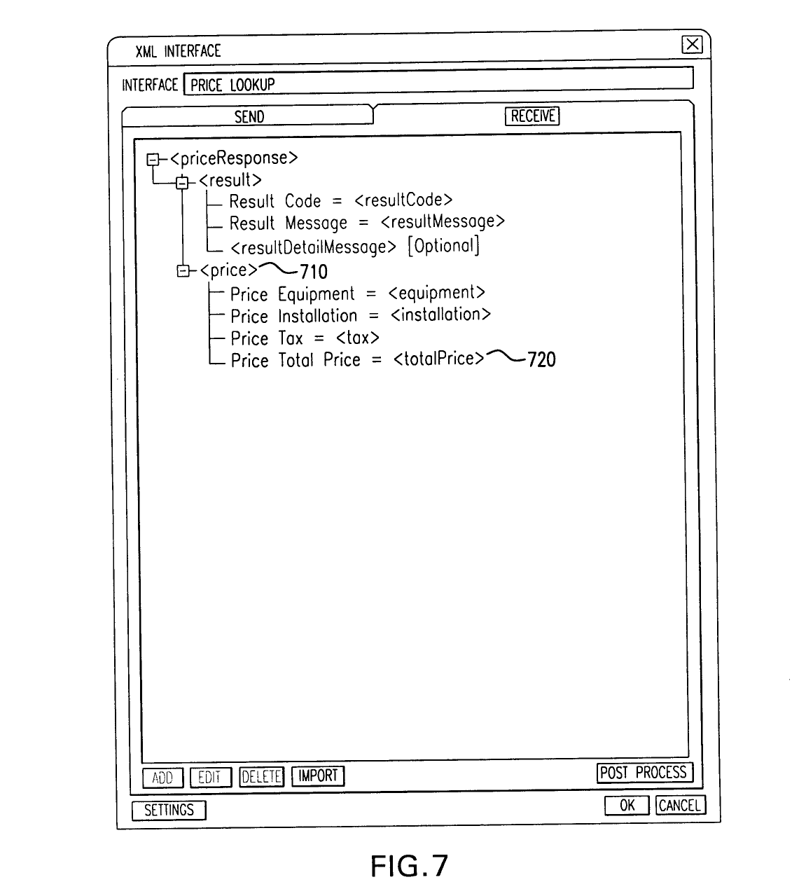

Additionally, FIG. 5 also shows an XML interface action. Price component 540 corresponds to the price section 440 of FIG. 4. Total Price field 541 corresponds to Total Price field 441. Price lookup button component 550 corresponds to price lookup button 450 of FIG. 4. Price lookup button component 550 corresponds to price lookup button 450. The developer creates a price lookup XML interface 580 and associates the interface with the price lookup button component 550. For an XML interface action, the developer specifies the URL of the XML interface. The editor 110 also contains graphical functionality to allow the user to associate the fields of the application with the tags of the XML interface. FIG. 6 shows a mapping between field components of FIG. 5 and XML tags for a price lookup request. For example, the service address field component 511 is associated with the addressLine tag 620 of the address record 610. The selectedProduct tag 630 contains a list of names. FIG. 7 shows a mapping between field components of FIG. 5 and XML tags for a price lookup response returned from a server. Price record 710 contains the information corresponding to the fields of price section 540 of FIG. 5. Total price tag 720 contains the total price value corresponding to total price field 541 of FIG. 5.

When the developer generates the application, the compiler 130 generates application platform-specific code that, when the price lookup button 450 is clicked, reads the data contained in the fields of the user's previously entered product list, constructs an XML price lookup request in accordance with FIG. 6, and sends the XML price request to the indicated server. The compiler 130 also generates the code necessary to receive the XML price lookup response from the server, extract the data from the XML response and map the response to the fields of the application in accordance with FIG. 7.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosures. The scope of the invention is to be defined only by the claims appended hereto, and by their equivalents.

What is claimed is:

1. A computer-readable medium having computer-executable instructions for performing a method for creating an interactive software application, the method comprising the steps of:
providing an editor;
providing a database;
providing a compiler;
defining a user interface for said interactive software application with said editor;
storing said user interface in said database;
determining an application platform; and
retrieving said user interface from said database and generating an interactive software application with said compiler based on the user interface and the application platform.

2. The computer-readable medium as claimed in claim 1, where the step of defining a user interface further comprises the step of defining a plurality of pages.

3. The computer-readable medium as claimed in claim 2, where the step of defining a plurality of pages further comprises defining a page layout for each page.

4. The computer-readable medium as claimed in claim 2, where the step of defining one or more pages further comprises defining one or more user interface components for each page.

5. The computer-readable medium as claimed in claim 2, where the step of defining a user interface further comprises defining navigation between the pages.

6. The computer-readable medium as claimed in claim 1, where the step of defining a user interface further comprises defining one or more functions for performing logic.

7. The computer-readable medium as claimed in claim 1, where the step of defining a user interface further comprises defining one or more data fields.

8. The computer-readable medium as claimed in claim 1, where the step of defining a user interface further comprises defining one or more interfaces adapted to access an external data repository.

9. The computer-readable medium as claimed in claim 8, wherein the external data repository is an XML document.

10. The computer-readable medium as claimed in claim 9, where the step of defining a user interface further comprises defining one or more data fields, further comprising the step of mapping one or more of the data fields to tags in the XML document.

11. The computer-readable medium as claimed in claim 8, wherein the external data repository is a database.

12. The computer-readable medium as claimed in claim 10, where the step of defining a user interface further comprises defining one or more data fields, further comprising the step of mapping one or more of the data fields to tags in the XML document.

13. The computer-readable medium as claimed in claim 1, where the step of defining a user interface further comprises creating one or more application modules, where each module comprises one or more pages.

14. The computer-readable medium as claimed in claim 1, wherein the user interface is stored in the database as metadata.

15. The computer-readable medium as claimed in claim 1, where the step of generating the application with the compiler further comprises the steps of:
generating pseudocode based on the user interface;
parsing the pseudocode based on the application platform; and
generating output code for the interactive software application based on the application platform.

16. The computer-readable medium as claimed in claim 2, where the step of generating the interactive software application further comprises the steps of:
generating pseudocode for each page;
parsing the pseudocode based on the application platform; and
generating output code for the interactive software application based on the application platform.

17. The computer-readable medium as claimed in claim 1, where the application platform is one of java server page, active server page, and PHP hypertext processor.

18. A computer-readable medium having computer-executable instructions for performing a method for creating an interactive software application, the method comprising the steps of:
selecting a user interface, where said user interface comprises a plurality of pages, each page having a page layout;
determining the order in which said pages are to be displayed to an end user;
storing said user interface and
generating a software application based on said user interface.

19. A computer-readable medium having computer-executable instructions for performing a method for creating an interactive software application, the method comprising the steps of:
providing a database for storing application modules;
providing an editor for creating and modifying application modules;
providing a compiler for generating an interactive software application;
creating an application module in said editor, each application module comprising a plurality of pages, each of said pages comprising one or more user interface elements and navigation logic for determining the next page to display;
storing said application module in said database;
generating a software application with said compiler, further comprising the substeps of:
retrieving one or more application modules from said database;
determining an application platform for said application; and
generating an application based on the application modules and application platform.

20. A system for creating an interactive software application, comprising:
a computer processor programmed to execute:
an editor adapted to create a user interface for an interactive software application;
a database adapted to store the user interface; and
a compiler adapted to retrieve the user interface from the database and generate the interactive software application based on the user interface and the application platform.
